(19) United States
(12) Patent Application Publication
(10) Pub. No.: US 2022/0340330 A1
(43) Pub. Date: Oct. 27, 2022

(54) PACKAGING BOX

(71) Applicant: KIMOTO CO., LTD., Saitama (JP)

(72) Inventor: Tomoyuki TAKEGASA, Saitama (JP)

(21) Appl. No.: 17/403,381

(22) Filed: Aug. 16, 2021

(30) Foreign Application Priority Data
Apr. 27, 2021 (JP) 2021-74716

(51) Int. Cl. B65D 5/68; B65D 5/46; B65D 85/672; B65D 5/32

(52) U.S. Cl. CPC B65D 5/68; B65D 5/46072; B65D 85/672; B65D 5/326

(57) ABSTRACT

A packaging box with improved strength in the vertical direction in a packing body housing a rolled product is provided. The packaging box comprises a lower case for forming a space for housing a rolled product, and an upper cover for sealing the space. The upper cover comprises a rectangular top board portion and a rectangular parallelepiped upper cover extending downward in the vertical Z direction from respective sides of the top board portion so as to cover almost all of the lower case. The upper cover is configured by a pair of narrow-width sideboard portions facing to each other in approximately parallel and a pair of wide-width sideboard portions facing to each other in approximately parallel, all formed to be integrated by a margin for sticking, and is provided to an end portion of at least one sideboard portion and superimposed on an inner surface on the space side of another sideboard portion to be connected. At a lower side of at least one sideboard portion, a cutout handle part is formed for lifting in the Z direction when unpacking. By holding the handle part and lifting, the packing body opens. The superimposed and fixed margin for sticking does not exist on an inner surface of a sideboard portion, where the handle part is formed.

### BACKGROUND OF THE INVENTION

### Field of the Invention

The present invention relates to a lid-and-body type, that is a two-piece type, packaging box suitable for packaging heavy rolled products, which are rolled long films.

### Description of the Related Art

As a packaging box of this kind, a packing body formed by covering a lower case housing a rolled product therein with an upper cover so as to pack a rolled product has been known (Patent Document 1). In the patent document 1, in order to improve efficiency of unpacking, it is proposed to configure the upper cover with a top board portion covering all of the inside of the lower case and a sideboard portion vertically extending downward from respective sides of the top board portion to cover approximately all side surfaces of the lower case, and to provide a cutout portion to any one of the lower sides of the upper cover.

### RELATED ART DOCUMENTS

### Patent Document

### Patent Document 1: Japanese Patent Unexamined Patent Publication (Kokai) No. 2016-84182

### SUMMARY OF THE INVENTION

In the technique in the patent document 1, however, when stacking two or more of the packing bodies housing rolled products inside, there has been a problem that the housed products get damaged due to insufficient strength of the packaging box in the vertical direction.

An object of the present invention is to provide a packaging box capable of improving strength in the vertical direction of the packing body housing a rolled product therein.

Below, to facilitate understanding of the present invention, an explanation will be made with reference numbers corresponding to those in the drawings illustrating an embodiment of the present invention, however, the present invention is not limited to those.

To attain the above object, the packaging box for rolled products (1) according to present invention comprises a lower case (2) for forming a space (23) for housing a rolled product, which is a long material rolled around an axis in the longitudinal (X) direction, and an upper cover (4), which extends downward in the vertical (Z) direction from respective sides of the top board portion (42), for sealing the space (23) in the lower case (2), wherein

the upper cover (4) comprises a rectangular top board portion (42) for sealing the space (23) in the lower case (2) and a rectangular parallelepiped upper cover (4) for covering almost all outer surface of the lower case (2);

the upper cover (4) is configured by a pair of narrow-width sideboard portions (44a, 44c) facing to each other in approximately parallel and a pair of wide-width sideboard portions (44b, 44d) facing to each other in approximately parallel, all formed to be integrated by a margin for sticking (46), which extends in the vertical (Z) direction and is provided to an end portion of at least one sideboard portion (44a, 44c, or 44a and 44c), superimposed on an inner surface on the space side of another sideboard portion (44d) to be connected; and

at a lower side of at least one sideboard portion (44a, 44c, or 44a and 44c) has a cutout handle part (52a, 52c) formed thereon for a hand to hook for lifting in the Z direction when unpacking. In this case, the packing body is unpacked by holding the handle part (52a, 52c) and lifting upward in the vertical (Z) direction. A superimposed and fixed margin for sticking (46) does not exist on an inner surface of a sideboard portion (44a, 44c, or 44a and 44c) where the handle part (52a, 52c) is formed.

The handle part (52a, 52c) may be a rectangular shape having corners and a lower long side thereof is open to form an upside-down U shape.

The upper cover is formed by preparing two first members (piece C, piece D), each of them has connected two sideboard portions (44a and 44b, or 44c and 44d) able to be folded at a fold line (45a, 45c) extending in the Z direction, and using a second member (refer to FIG. 2B) obtained by connecting the two first members.

A sideboard portion (44a, 44c, or 44a and 44c) formed with the handle part (52a, 52c) may have a pair of perforations (49a and 49a, or 49c and 49c) extending upward from a lower end thereof toward the top board portion (42) and, in this case, when cutting both of the perforations (49a and 49a, or 49c and 49c), it may be configured that a sideboard piece (50) surrounded by the perforations (49a and 49a, or 49c and 49c) and the lower side of the sideboard portion (44a, 44c, or 44a and 44c) can be detached. By holding the handle part (52a, 52c) and lifting upward in the vertical (Z) direction while pulling outward (toward oneself), both of the perforations (49a and 49a, or 49c and 49c) can be cut easily.

The pair of perforations (49a and 49a, or 49c and 49c) may be formed at predetermined positions, which are positions axisymmetric with respect to a straight line extending in the Z direction at the center in a width (X or Y) direction of a sideboard portion (44a or 44c), and/or closer to the center being away in the width (X or Y) direction from both ends of the sideboard portions (44a, 44c).

The perforations (49a and 49a, or 49c and 49c) are configured by a line of collective small holes, a cut length of the small holes in the Z direction may be 5 mm or more and 50 mm or less and a distance (remaining length) between two small holes adjacent in the Z direction may be 2 mm or more and 20 mm or less.

The perforations (49a and 49a, or 49c and 49c) may be formed to be extending upward toward the top board portion (42) from an upper end of both short sides on right and left of the handle part (52a, 52c) formed to be an upside-down U shape.

The packaging box according to the present invention has a cutout handle part for a hand to hook for unpacking formed on at least one of a plurality of sideboard portions configuring a body part of the upper cover, and a superimposed and fixed margin for sticking extending in the vertical direction, which is for connecting the sideboard portion with another sideboard portion to be integrated so as to form a body part of the upper cover, does not exist on an inner surface of a sideboard portion where the handle part is formed. Since it is configured that the superimposed and fixed portion exists on an inner surface of other sideboard portion, the packing body formed for packing a rolled product can obtain improved strength in the vertical direction when comparing with the case of packing in a packaging box having a conventional configuration.

Note that “packing a rolled product” has the same meaning as producing a packing body. “Packing body” indicates what housing (packing) a rolled product as an object to be packed in the packaging box of the present invention.

### BRIEF DESCRIPTION OF DRAWINGS

FIG. 1A is a perspective view showing an exemplified use condition of a packaging box according to an embodiment of the present invention.

FIG. 1B is a perspective view showing an example of an upper cover composing the packaging box in FIG. 1A.

FIG. 1C is a perspective view showing an example of a lower case composing the packaging box in FIG. 1A/

FIG. 1D is an explanatory view of an example of around a lower end of a narrow-width sideboard portion 44a composing the upper cover in FIG. 1B.

FIG. 1E is an enlarged view of a 1E part surrounded by a dot-dash-line in FIG. 1B.

FIG. 1F is a perspective view showing another example of the upper cover composing the packaging box in FIG. 1A.

FIG. 2A is an exemplified view of a deployed state of the upper cover in FIG. 1B.

FIG. 2B is an exemplified view of preparing pieces in the deployed state in FIG. 2A.

FIG. 2C is an exemplified view of the lower case in FIG. 1C in a deployed state.

FIG. 2D is an exemplified view of preparing pieces in the deployed state in FIG. 2C.

FIG. 3 is an exemplified perspective view showing the lower case in FIG. 1C in a used state.

FIG. 4 is an exemplified perspective view of an unpacked state of the packing body holding a rolled product in the packaging box in FIG. 1A.

### DETAILED DESCRIPTION OF THE INVENTION

Below, embodiment(s) of the packaging box according to the present invention will be explained with reference to the drawings.

First, an overview of the entire configuration will be explained.

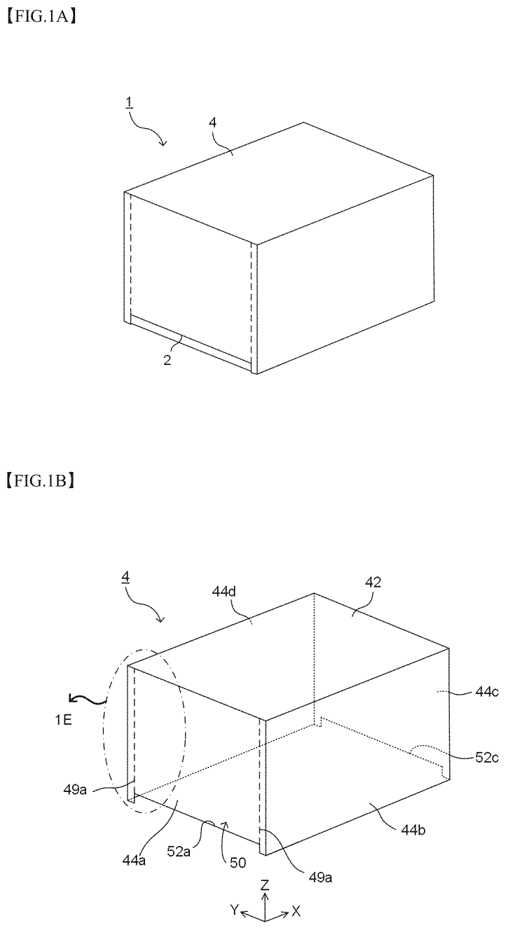

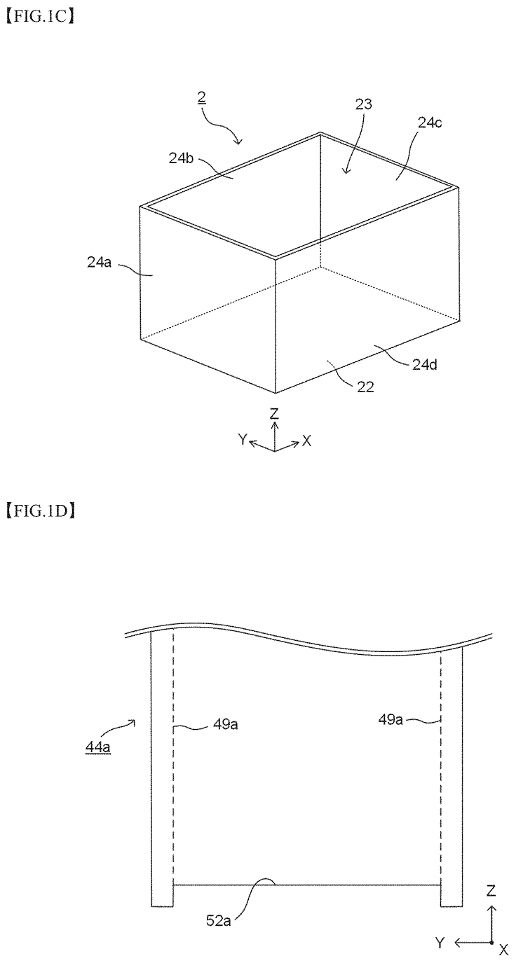

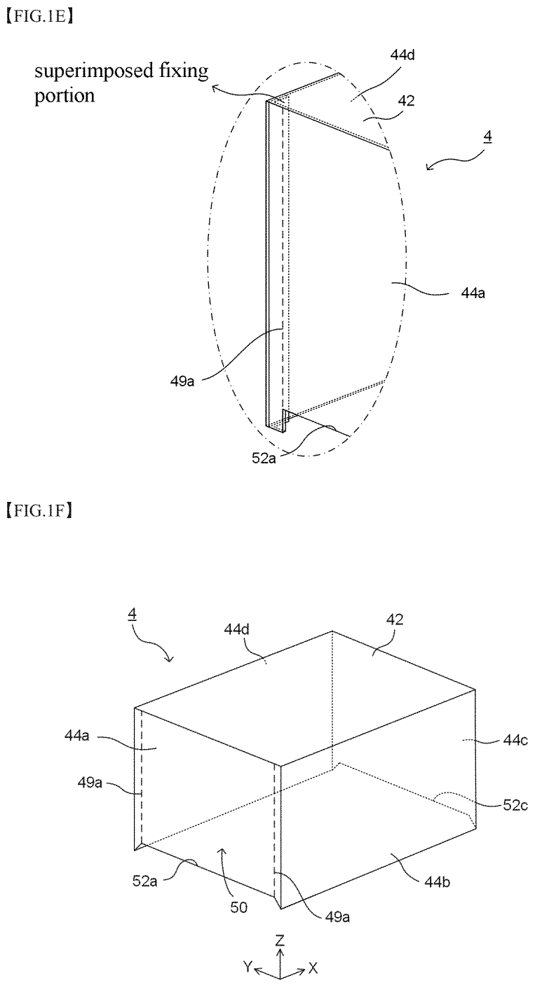

As shown in FIG. 1A, FIG. 1B and FIG. 1C, the packaging box 1 for rolled product according to an embodiment of the present invention (hereinafter, simply referred to as “the packaging box 1”) is used for housing (refer, for example, to FIG. 3) and packing a rolled product, which is a long material rolled around an axis in the longitudinal X direction (hereinafter, simply referred to as “the X direction”), and comprises a lower case 2 forming a space 23 for housing the rolled product and an upper cover 4 for sealing the space 23 of the lower case 2. It is configured to be a lid-and-body type, that is a two-piece type.

As shown in FIG. 1C, the lower case 2 has, at its lower part, a rectangular bottom board portion 22 having a pair of long sides extending along the X direction and a pair of short sides extending along the width Y direction perpendicular to the X direction (hereinafter, simply referred to as “the Y direction”).

At the respective sides (long sides and short sides) of the bottom board portion 22, a pair of narrow-width sideboard portions 24a and 24c facing to each other in approximately parallel and a pair of wide-width sideboard portions 24b and 24d facing to each other in approximately parallel position upright in the vertical Z direction (hereinafter, simply referred to as “the Z direction”) perpendicular to both of the X and Y directions so as to connect both side end portions of the narrow-width sideboard portions 24a and 24c. The four sideboard portions 24a, 24b, 24c and 24d configure the rectangular parallelepiped lower box body part. A space surrounded by the four sideboard portions 24a, 24b, 24c and 24d is a space 23 for housing a rolled product (refer to FIG. 3) on the bottom board portion 22. To close the space 23 surrounded by the sideboard portions 24a, 24b, 24c and 24d, the upper cover 4 is placed downward in the Z direction to cover from the upper end sides of the sideboard portions 24a, 24b, 24c and 24d. A rate of the long sides and the short sides on the bottom board portion 22 side of the space 23 is determined in consideration of an axis length (X direction) of the rolled product to be housed and a diameter (Y direction) of a rolled long product. The ratio of the long side and short side is about 2:1 in one mode.

As shown in FIG. 1B, the upper cover 4 has, at its upper portion, a rectangular top board portion 42 for sealing the space 23 of the lower case 2. The top board portion 42 has a pair of long sides extending along the X direction and a pair of short sides extending along the Y direction. At the respective sides of the top board portion 42, a pair of narrow-width sideboard portions 44a and 44c facing to each other in approximately parallel and a pair of wide-width sideboard portions 44b and 44d facing to each other in approximately parallel, which connect both end portions of the narrow-width sideboard portions 44a and 44c, extend downward in the Z direction. These four sideboard portions 44a, 44b, 44c and 44d form the rectangular parallelepiped upper cover. The upper cover is designed to be a size (refer to FIG. 1A) capable of covering approximately all of the lower case portion (sideboard portions 24a, 24b, 24c and 24d) of the lower case 2 shown in FIG. 1C from outside.

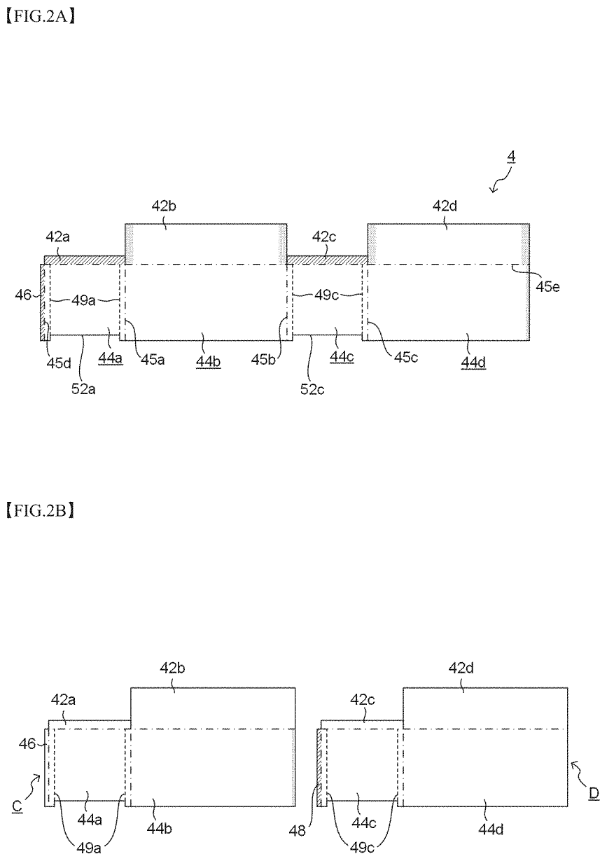

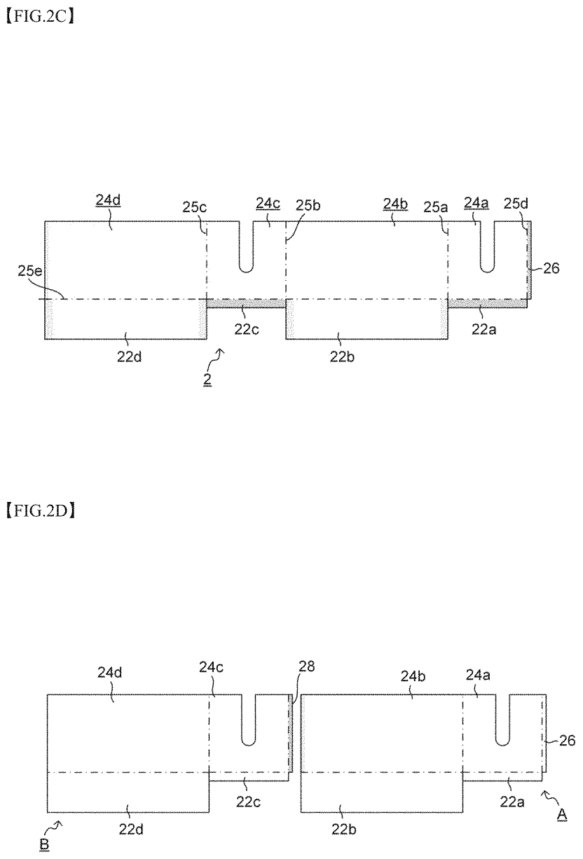

The lower case 2 and the upper cover 4 are formed by paper or plastic cardboard (hereinafter, referred to as “a cardboard plate”), for example, as shown in FIG. 2A and FIG. 2C. Both or either one of the lower case 2 and the upper cover 4 may be formed by other material (for example, a thick paper, kraft paper, paper board and plastic plate, etc.) besides cardboard plates. A thickness of the cardboard plate, etc. to be used is not particularly limited and may be determined arbitrarily in a range that required strength can be secured. It may be, for example, about 5 mm or thicker and 20 mm or thinner (about 8 mm as an example).

Next, an example of deployed structure will be explained.

As shown in FIG. 2C, four sideboard portions 24a, 24b, 24c and 24d forming a body part of the lower case 2 are connected and able to be folded at fold lines 25a, 25b and 25c. A margin for sticking 26 is provided to the narrow-width sideboard portion 24a via the fold line 25d at its end portion on the opposite side of the wide-width sideboard portion 24b.

The bottom board portion 22 (refer to FIG. 1C) may be configured by four bottom lid flaps 22a, 22b, 22c and 22d connected to below the sideboard portions 24a, 24b, 24c and 24d via the fold line 25e.

The lower case 2 of the present example having the deployed structure as above may be assembled as explained below.

First, the narrow-width sideboard portion 24a is folded at the fold line 25a, the wide-width sideboard portion 24b is folded at the fold line 25b and the narrow-width sideboard portion 24c is folded at the fold line 25c at an angle of 90 degrees, respectively. Then, the margin for sticking 26 provided to the narrow-width sideboard portion 24a is folded at the fold line 25d at an angle of 90 degrees, brought to superimpose with the wide-width sideboard portion 24d so that the margin 26 comes inward and fixed. The fixing means is not particularly limited and may be fixed with an adhesive agent, etc.

Next, a pair of inner flaps (bottom lid flaps 22a and 22c) are folded at the fold line 25e at an angle of 90 degrees, then a pair of outer flaps (bottom lid flaps 22b and 22d) are folded at the fold line 25e at an angle of 90 degrees so as to cover over the inner flaps. In a state where ends of both of the outer flaps meet, they are connected with a not shown means for connecting the flaps (an adhesive tape, etc.). As explained above, the lower case 2 is assembled.

Note that, as the lower case 2 in the present example, other than the integrally-formed cardboard configured as shown in FIG. 2C, what formed from a plurality of pieces as shown, for example, in FIG. 2D may be used, as well. Specifically, for example, a method of preparing a piece A and a piece B and putting them together via a margin for sticking 28 to obtain a cardboard plate (obtained by preparing a piece A composed of the narrow-width sideboard portion 24a, wide-width sideboard portion 24b, bottom lid inner flap 22a, bottom lid outer flap 22b and margin for sticking 26 and a piece B composed of the narrow-width sideboard portion 24c, wide-width sideboard portion 24d, bottom lid inner flap 22c, bottom lid outer flap 22d and margin for sticking 28, superimposing the margin for sticking 28 of the piece B on the wide-width sideboard portion 24b of the piece A, so that the margin for sticking 28 comes on an inner surface of the space 23 when assembled, and fixing with an adhesive agent, etc.), etc. may be mentioned. When configuring the lower box material with a plurality of pieces as above, the box materials take up less space when storing and, moreover, since there are a plurality of superimposed portions for fixing in the Z direction (two in this example) after assembling, furthermore improvement is expected in strength in the Z direction to be secured.

As shown in FIG. 2A, the four sideboard portions 44a, 44b, 44c and 44d composing the body part of the upper cover 4 are connected and able to be folded at fold lines 45a, 45b and 45c. A margin for sticking 46 is provided to the narrow-width sideboard portion 44a via the fold line 45d at its end portion on the opposite side of the wide-width sideboard portion 44b.

The top board portion 42 (refer to FIG. 1B) may be configured by four upper lid flaps 42a, 42b, 42c and 42d connected to the upper side of the sideboard portions 44a, 44b, 44c and 44d via the fold line 45e as shown, for example, in FIG. 2A.

The upper cover 4 in the present example having the deployed structure as above is assembled as explained below.

First, the narrow-width sideboard portion 44a is folded at the fold line 45a, the wide-width sideboard portion 44b is folded at the fold line 45b, and the narrow-width sideboard portion 44c is folded at the fold line 45c, then, the margin for sticking 46 provided to the narrow-width sideboard portion 44a is folded at the fold line 45d at an angle of 90 degrees, superimposed on the wide-width sideboard portion 44d, so that the margin 46 comes inside and fixed. Namely, when assembled, inside the narrow-width sideboard portion 44a formed with the handle part 52a does not have any superimposed fixing portion of the margin for sticking 46 (refer to FIG. 1E). The fixing means is not particularly limited and an adhesive agent, etc. may be mentioned.

Next, a pair of inner flaps (the upper lid flaps 42a and 42c) are folded at the fold line 45e and, then, a pair of outer flaps (upper lid flaps 42b and 42d) are folded at the fold line 45e. In a state where ends of the outer flaps meet, they are connected by a not shown means for connecting the flaps (an adhesive tape, etc.). In this way, the upper cover 4 is assembled.

Note that, as the upper cover 4 in the present example, other than the integrally formed cardboard plate as shown in FIG. 2A, what formed by a plurality of pieces, for example, as shown in FIG. 2B may be used, as well.

Specifically, a cardboard plate obtained, for example, by preparing a piece C and a piece D (both are an example of a first member) and connecting the two via the margin for sticking 48 (a piece C (first member) composed of the narrow-width sideboard portion 44a, wide-width sideboard portion 44b, upper lid inner flap 42a, upper lid outer flap 42b and margin for sticking 46 and a piece D (first member) composed of the narrow-width sideboard portion 44c, wide-width sideboard portion 44d, upper lid inner flap 42c, upper lid outer flap 42d and margin for sticking 48 are superimposed so that the margin for sticking 48 of the piece D comes inside of the wide-width sideboard portion 44b of the piece C when assembled and fixed by an adhesive), etc. may be mentioned. When the upper lid member is configured by a plurality of pieces as above, the lid materials take up less space when storing and, moreover, since there are a plurality of superimposed portions for fixing in the Z direction (two in this example) after assembling, furthermore improvement is expected in strength in the Z direction to be secured.

Next, an explanation will be made on characteristic part of the present example.

<Handle Part>

In one mode, as shown in FIG. 1B and FIG. 2A, among the four sideboard portions composing the upper cover part of the upper cover 4, lower sides (lower ends) of the narrow-width sideboard portions 44a and 44c extending downward in the Z direction from both short sides of the top board portion 42 are formed with handle parts 52a and 52c for an operator to hook his/her hands when lifting upward in the Z direction at unpacking. Thereby, it becomes easy to hook finger(s) at the lower end of the upper cover 4 when unpacking the packaging box 1, which contributes to workability when unpacking the packaging box 1. Here, “unpacking” means an operation of opening the packing body.

In the present example, as shown in FIG. 2A, it is configured that no superimposed and fixed portion of the margin for sticking 46 exists on an inner surface of the narrow-width sideboard portion 44a, on which the handle part 52a is formed, so that strength in the Z direction is secured. When using what formed by a plurality of pieces as shown in FIG. 2B, there are a plurality of superimposed and fixed portions, so that the strength in the Z direction improves furthermore.

A position, size and shape of the handle parts 52a and 52c to be provided are not particularly limited, but preferably they are at positions of equal distance from both end portions in the Y direction. The handle parts 52a and 52c may have a size (a width in the Y direction) allowing one or two fingers of an operator to hook. Their shape may be decided freely. In terms of easiness of forming, for example, an upside-down U shape (refer to FIG. 1D) is basic, which is a rectangular shape having corners and with the lower long side open, and it is preferable that the shape is suitably modified but it is not limited to this shape. It may be a trapezoidal shape having corners and with the bottom side (the long side) open (refer to FIG. 1F) or may be an arc shape with no corners (not shown).

The handle part may be provided only on one end portion of the narrow width sideboard portions 44a and 44c. Onsite operation may be often done by only one person, so that considering such situation, a handle part 52a (or 52c) only on one narrow-width sideboard portion 44a (or 44c) would be able to improve workability sufficiently and it may also result in reducing production cost of the upper cover 4.

<Perforations>

Although it is not essential in the present invention, in one mode, a pair of narrow-width sideboard portions 44a and 44c may be provided with a pair of perforations 49a and 49a and perforations 49c and 49c running upward in the Z direction from lower ends (already mentioned above), which is the opposite side from the upper top board portion 42 side. The running direction of the perforations 49a, 49a, 49c and 49c is not strictly along the Z direction and would be enough if they run from the lower ends of the narrow-width sideboard portions 44a and 44c toward the direction of the top board portion 42. Here, “toward the direction of the top board portion 42” includes running in the direction of some angle from the Z direction.

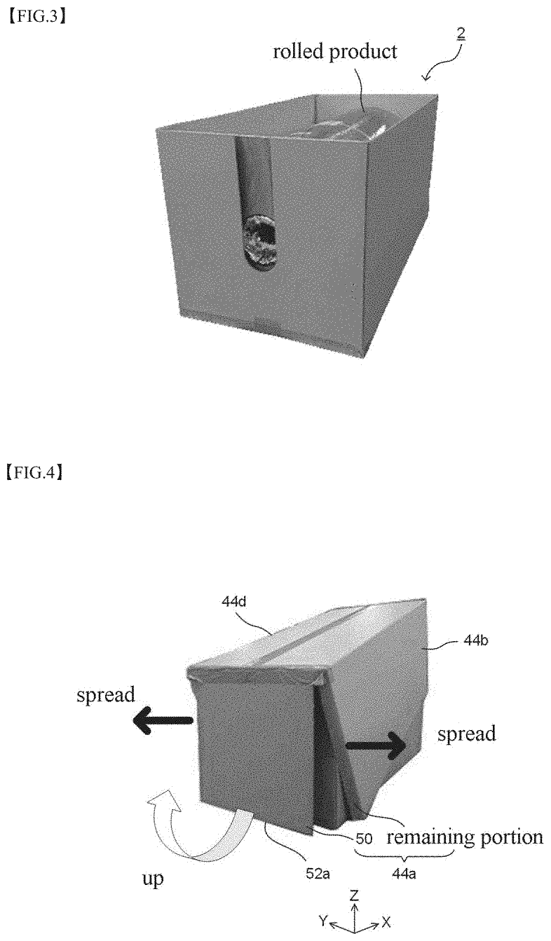

The perforations 49a, 49a, 49c and 49c in the present example are configured by collective small holes lined up along the Z direction. When a pair of perforations 49a and 49a (or 49c and 49c) are cut, a sideboard piece 50 (refer to FIG. 4) surrounded by sides (lower sides) of the narrow-width sideboard portion 44a (or 44c) on the opposite side of the top board portion 42 and the pair of perforations 49a and 49a (or 49c and 49c) can be detached from the rest (refer to FIG. 4) of the narrow-width sideboard portion 44a (or 44c).

“Positions” of arranging the pair of perforations 49a and 49a (or 49c and 49c) are not particularly limited but, for example, as shown in FIG. 1B and FIG. 2A, positions axisymmetric with respect to a straight line extending in the Z direction at the center in the Y direction of the narrow-width sideboard portion 44a (or 44c) are preferable. More preferably, the perforations are formed at predetermined positions, which are close to the center (inner side) from the both ends in the Y direction keeping a predetermined distance from the ends (for example, 0.5 mm or more and 1500 mm or less, preferably 10 mm or more and 1000 mm or less and more preferably 30 mm or more and 70 mm or less). When the “positions” of a pair of perforations 49a and 49a (or 49c and 49c) are closer to the center from the both ends in the Y direction (mentioned above), it becomes easier to cut the perforations 49a and 49a (or 49c and 49c), however, when they are formed too close to the center (mentioned above), it is liable that adjacent narrow-width sideboard portions 44b and 44d become hard to open when cutting the perforations 49a and 49a (or 49c and 49c).

“A length of the line of small holes (in the Z direction)” forming the perforations 49a, 49a, 49c and 49c is not particularly limited but in terms of easiness of cutting and strength, it is desired to be, for example, 5 mm or more and 50 mm or less or so and preferably 10 mm or more and 40 mm or less. When the length of the line is long, it becomes easier to cut the perforations 49a, 49a, 49c and 49c, however, when it is too long, strength in the Z direction tends to decline. “A distance between adjacent two holes (remaining length in the Z direction)” is not particularly limited, either, however, in terms of easiness of cutting, it is desired to be, for example, 2 mm or more and 20 mm or less or so and preferably 5 mm or more and 15 mm or less. When the remaining length is too long, it is liable that perforations 49a, 49a, 49c and 49c become hard to be cut.

“A width of the small holes (in the Y direction)” forming the perforations 49a, 49a, 49c and 49c is not particularly limited, either, however, when it is too large, strength in the Z direction tends to decline. Therefore, “a width of the small holes (Y direction)” may be designed arbitrarily in a range of maintaining the strength.

It is preferable that the perforations 49a, 49a, 49c and 49c are formed from the lower end to the upper end of the narrow-width sideboard portions 44a and 44c as shown in FIG. 1B and FIG. 2A, however, it is not always necessary to form to the upper end and may be formed halfway. A length of the perforations 49a, 49a, 49c and 49c from the lower end of the narrow-width sideboard portions 44a and 44c toward the top board portion 42 (hereinafter, simply referred to as “a length of perforations”) may be two thirds of the full length from the lower end to the upper end of the narrow-width sideboard portions 44a and 44c (hereinafter, simply referred to as “the height of the sideboard portion”). When the length of perforations is two thirds of the height of the sideboard portion, the effect of the invention can be expected.

Note that, when handle parts 52a and 52c provided to the pair of narrow-width sideboard portions 44a and 44c have an upside-down U shape as shown in FIG. 1D, it is preferable that the perforations 49a and 49c are provided upward in the Z direction from the upper ends of both short sides on the right and left of the rectangle as shown in FIG. 1B and FIG. 2A. On the other hand, when the handle parts 52a and 52c provided to the pair of narrow-width sideboard portions 44a and 44c are the shape as shown in FIG. 1F, the perforations 49a and 49c are preferably provided upward in the Z direction from both ends of the top side of the trapezoid as shown in FIG. 1B and FIG. 2A.

Next, the effects will be explained.

When unpacking a packing body, which is a packaging box 1 housing a rolled product, (that is, an operation of opening the packing body), the operator stands in front of either one (for example, the narrow-width sideboard portion 44a) of the narrow-width sideboard portions 44a and 44c of the upper cover 4 as shown in FIG. 1B and FIG. 4 first, then, while bending down a bit, he/she hooks his/her finger(s) at the handle part 52a of the narrow-width sideboard portion 44a.

When the perforations 49a and 49s and perforations 49c and 49c shown in FIG. 1B and FIG. 2A are not provided at the lower end (mentioned above) of the narrow-width sideboard portions 44a and 44c, in a state where the operator's finger(s) hooked at the handle part 52a, the operator lifts in the Z direction. Thereby, the packing body with no perforations provided thereon is unpacked.

On the other hand, when perforations 49a, 49a, 49c and 49c shown in FIG. 1B and FIG. 2A are provided at the lower end (mentioned above) of the narrow-width sideboard portions 44a and 44c, the operator cuts the perforations 49a and 49a by lifting in the Z direction while pulling toward himself/herself in the X direction with his/her finger(s) hooked at the handle part 52a and pushes up the sideboard piece 50 surrounded by the handle part 52a and a pair of perforations 49a and 49a. When the sideboard piece 50 is cut out from the narrow-width sideboard portion 44a, an air goes naturally into inside the upper cover 4, and the wide-width sideboard portions 44b and 44d opens as a result of pushing up the sideboard piece 50 (refer to FIG. 4), so that efficiency of unpacking improves.

Also, while pushing up the sideboard piece 50, the operator holds the other handle part 52c and lifts the other narrow-width sideboard portion 44c upward in the Z direction. During this, he/she may either cut or not cut the perforations 49c and 49c. From the above, opening of the packing body when perforations 49a, 49a, 49c and 49c are provided completes.

According to the packaging box 1 in the present example, among a plurality of sideboard portions configuring the rectangular parallelepiped body portion of the upper cover 4, the narrow-width sideboard portions 44a and 44c extending downward in the Z direction from both short sides of the top board portion 42 are formed with the handle parts 52a and 52c in a cutout shape for finger(s) to hook when unpacking. Together with this, it is configured that, on an inner surface of the narrow-width sideboard portions 44a and 44c, on which the handle part 52a and 52c are formed, a superimposed and fixed portion of the margins for sticking 46 and 48 extending in the Z direction, which are for connecting the narrow-width sideboard portions 44a and 44c with other wide-width sideboard portions 44b and 44d to be integral so as to form a body part of the upper cover 4, does not exist and the superimposed and fixed portion comes on an inner surface of other wide-width sideboard portions 44b and 44d. Therefore, comparing with the case of packing in a packaging box of the conventional configuration, wherein no superimposed and fixed portion of a margin for sticking exists on any sideboard portion (for example, the technique according to the patent document 1), strength in the Z direction can be enhanced in the packing body formed by packing a rolled product.

The embodiment explained above is described for facilitating understanding of the present invention and is not for limiting the present invention. Accordingly, respective elements disclosed in the embodiment above may include all design modifications and equivalent belonging to the technical range of the present invention.

### DESCRIPTION OF NUMERICAL NOTATIONS

1 . . . packaging box
2 . . . lower case
22 . . . bottom board portion
22a, 22c . . . bottom lid inner flaps (inner flaps)
22b, 22d . . . bottom lid outer flap (outer flap)
23 . . . housing space
24a, 24c . . . narrow-width sideboard portion (sideboard portion)
24b, 24d . . . wide-width sideboard portion (sideboard portion)
25a, 25b, 25c, 25d and 25e . . . fold line
26, 28 . . . margin for sticking
4 . . . upper cover
42 . . . top board portion
42a, 42c . . . upper lid inner flap (inner flap)
42b, 42d . . . upper lid outer flap (outer flap)
44a, 44c . . . narrow-width sideboard portion (sideboard portion)
44b, 44d . . . wide-width sideboard portion (sideboard portion)
45a, 45b, 45c, 45d, 45e . . . fold line
46, 48 . . . margin for sticking
49a and 49c . . . perforation
50 . . . sideboard piece
52a, 52c . . . handle part

1. A packaging box for a rolled product, comprising a lower case for forming a space for housing a rolled product, which is a long material rolled around an axis in the longitudinal (X) direction, and an upper cover for sealing the space in the lower case, wherein
the upper cover comprises a rectangular top board portion for sealing the space in the lower box body and a rectangular parallelepiped upper cover, which are extending downward in the vertical (Z) direction from respective sides of the top board portion, for covering approximately all of outer side surfaces of the lower box body;
the upper cover is configured by a pair of narrow-width sideboard portions facing to each other in approximately parallel and a pair of wide-width sideboard portions facing to each other in approximately parallel, all formed to be integrated by a margin for sticking, which extends in the Z direction and is provided to an end portion of at least one sideboard portion, superimposed on an inner surface on the space side of another sideboard portion to be connected; and
at a lower side of at least one sideboard portion is formed with a cutout handle part for a hand to hook for lifting in the Z direction when unpacking, and a superimposed and fixed margin for sticking does not exist on an inner surface of a sideboard portion where the handle part is formed.

2. The packaging box according to claim 1, wherein the handle part is a rectangular shape having corners and a lower long side thereof is open to form an upside-down U shape.

3. The packaging box according to claim 2, wherein the upper cover is formed by preparing two first members, each of them has connected two sideboard portions able to be folded at a fold line extending in the Z direction, and using a second member obtained by connecting the two first members.

4. The packaging box according to claim 3, wherein a sideboard portion formed with the handle part has a pair of perforations extending upward from a lower end thereof toward the top board portion and, when cutting both of the perforations, a sideboard piece surrounded by the perforations and the lower side of the sideboard portion can be detached.

5. The packaging box according to claim 4, wherein the pair of perforations are formed at predetermined positions, which are positions axisymmetric with respect to a straight line extending in the Z direction at the center in a width (X or Y) direction of a sideboard portion, and closer to the center being away from both ends in the width (X or Y) direction.

6. The packaging box according to claim 5, wherein the perforations are configured by a line of collective small holes, a cut length of the small holes in the Z direction is 5 mm or more and 50 mm or less and a distance (remaining length) between two small holes adjacent in the Z direction is 2 mm or more and 20 mm or less.

7. The packaging box according to claim 6, wherein the perforations are formed to be extending upward toward the top board portion from an upper end of both short sides on right and left of the handle part formed to be an upside-down U shape.

8. The packaging box according to claim 1, wherein the upper cover is formed by preparing two first members, each of them has connected two sideboard portions able to be folded at a fold line extending in the Z direction, and using a second member obtained by connecting the two first members.

9. The packaging box according to claim 1, wherein a sideboard portion formed with the handle part has a pair of perforations extending upward from a lower end thereof toward the top board portion and, when cutting both of the perforations, a sideboard piece surrounded by the perforations and the lower side of the sideboard portion can be detached.

10. The packaging box according to claim 2, wherein a sideboard portion formed with the handle part has a pair of perforations extending upward from a lower end thereof toward the top board portion and, when cutting both of the perforations, a sideboard piece surrounded by the perforations and the lower side of the sideboard portion can be detached.

11. The packaging box according to claim 9, wherein the pair of perforations are formed at predetermined positions, which are positions axisymmetric with respect to a straight line extending in the Z direction at the center in a width (X or Y) direction of a sideboard portion, and closer to the center being away from both ends in the width (X or Y) direction.

12. The packaging box according to claim 10, wherein the pair of perforations are formed at predetermined positions, which are positions axisymmetric with respect to a straight line extending in the Z direction at the center in a width (X or Y) direction of a sideboard portion, and closer to the center being away from both ends in the width (X or Y) direction.

13. The packaging box according to claim 4, wherein the perforations are configured by a line of collective small holes, a cut length of the small holes in the Z direction is 5 mm or more and 50 mm or less and a distance (remaining length) between two small holes adjacent in the Z direction is 2 mm or more and 20 mm or less.

14. The packaging box according to claim 4, wherein the perforations are formed to be extending upward toward the top board portion from an upper end of both short sides on right and left of the handle part formed to be an upside-down U shape.

15. The packaging box according to claim 5, wherein the perforations are formed to be extending upward toward the top board portion from an upper end of both short sides on right and left of the handle part formed to be an upside-down U shape.
